(19) United States
(12) Patent Application Publication
(10) Pub. No.: US 2009/0187850 A1
(43) Pub. Date: Jul. 23, 2009

(54) SYSTEM AND METHOD FOR MULTI-SCREEN EXPERIENCE

(76) Inventors: Chris Hannan, Los Angeles, CA (US); Clark Pierce, Los Angeles, CA (US)

Correspondence Address: Cantor Colburn LLP - Fox Entertainment Group, 20 Church Street, 22nd Floor, Hartford, CT, 06103, US

(21) Appl. No.: 12/356,800

(22) Filed: Jan. 21, 2009

Related U.S. Application Data
(60) Provisional application No. 61/011,866, filed on Jan. 22, 2008.

(51) Int. Cl. G06F 3/048

(52) U.S. Cl. 715/783

(57) ABSTRACT

A system and method for multi-screen experience, which comprises provision of multiple screens of information to a viewer at the same time. In an exemplary embodiment, a plurality of screens, each showing different angles of an event, are simultaneously provided to the user. In another exemplary embodiment, a given screen may be selected for full screen viewing or deselected for multi-screen viewing. In another exemplary embodiment, an identifier indicates, charts or illustrates how a given screen relates to an event.

### CROSS REFERENCE TO RELATED APPLICATIONS

The present application claims priority to U.S. Provisional Patent Application Ser. No. 61/011,866 filed Jan. 22, 2008, the entire contents of which are specifically incorporated by reference herein.

### BACKGROUND

Effective sports coverage relies upon precise editing of footage from various cameras and various angles to provide coverage of important events from the sport. For example, effective switching between cameras and angles in basketball depends on ball position, game flow, fouls, etc. Ineffective switching prevents the viewer from understanding the plays and/or frustrates the viewer.

The marketplace would benefit from improved and effective ways to provide important sports information to the user.

### SUMMARY

The above described and other disadvantages of the prior art are overcome and alleviated by the presently described system and method for multi-screen experience, which comprises provision of multiple screens of information to a viewer at the same time. In an exemplary embodiment, a plurality of screens, each showing different angles of an event, are simultaneously provided to the user. In another exemplary embodiment, a given screen may be selected for full screen viewing or deselected for multi-screen viewing. In another exemplary embodiment, an identifier indicates, charts or illustrates how a given screen relates to an event.

### BRIEF DESCRIPTION OF THE DRAWINGS

Referring now to the drawings, wherein like elements are numbered alike in the following FIGURES:

FIG. 1 is an exemplary visual display depiction of an exemplary multi-screen race event;

FIG. 2 is a time progressed exemplary visual display depiction as shown in FIG. 1;

FIG. 3 is a time progressed exemplary visual display depiction as shown in FIG. 2;

FIG. 4 is a time progressed exemplary visual display depiction as shown in FIG. 3.

### DETAILED DESCRIPTION

Reference will now be made in detail to exemplary embodiments, examples of which are illustrated by the accompanying drawings. As indicated above, the presently described system and method for multi-screen experience comprises provision of multiple screens of information to a viewer at the same time.

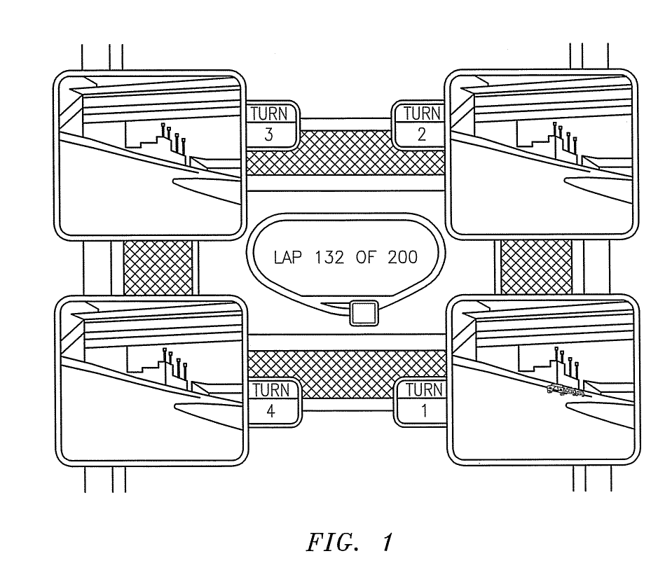

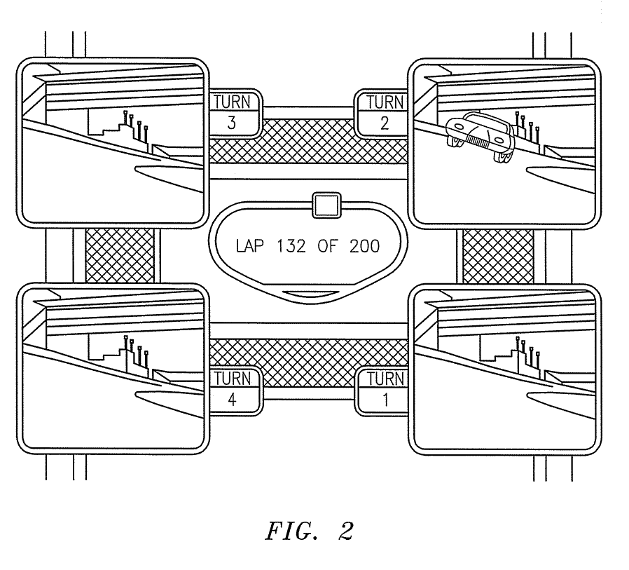

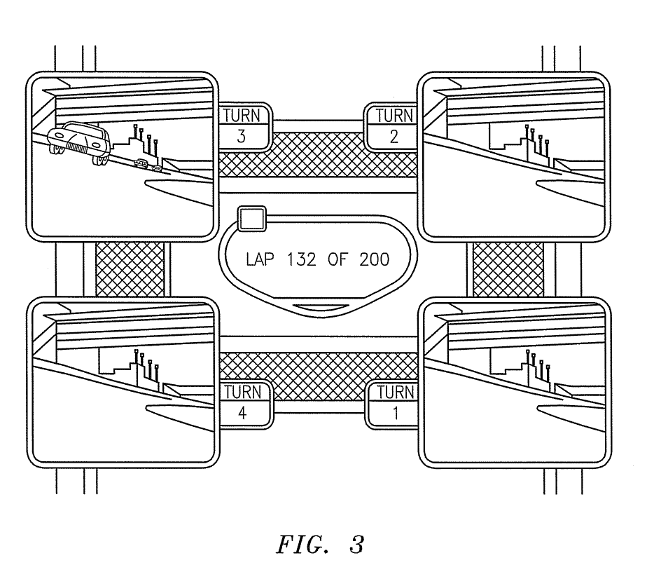

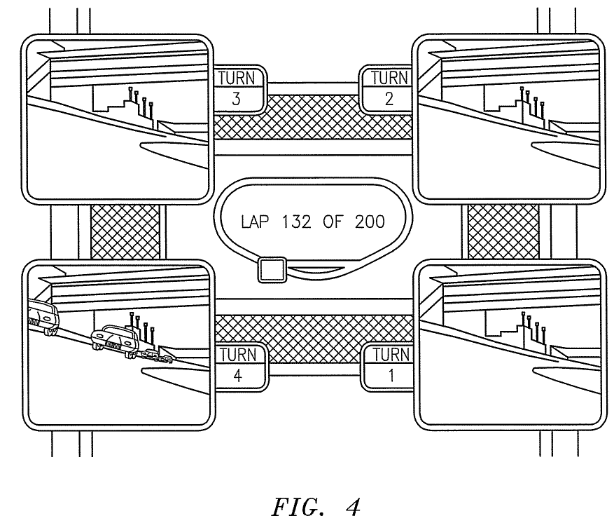

FIG. 1 illustrates an exemplary system implemented for an automobile race. Referring to FIG. 1, four separate screens are illustrated, covering an angle of and respectively labeled for turns 1, 2, 3 and 4 of the racetrack. In the illustrated exemplary embodiment, the interface includes labels for the turns (“TURN 1”, “TURN 2”, “TURN 3” and “TURN 4”). The display also provides indication of the progression of the event, in this case, position of a portion of the field or a lead car on the track and an indication of the current number of laps out of a race total. FIG. 2 shows activity in TURN 2, FIG. 3 shows activity in TURN 3 and FIG. 4 shows activity in TURN 4.

In exemplary embodiments, a given screen may be selected for full screen viewing or deselected for multi-screen viewing. Such selection may be via an appropriate input device for network or Internet broadcasts, or via a remote or other appropriate input for television, satellite, cable, etc., broadcasts or for pre-recorded broadcasts.

In another exemplary embodiment, only screens showing activity are illustrated. Such screens may popup or cycle through the interface during active moments, and disappear or cycle off the screen for inactive moments.

In another exemplary embodiment, a viewer may select from a plurality of screens those screens the viewer would like to view. Thus, should the user prefer TURN 4 and the Pit, the user may select to view only those two cameras.

This system also has great advantage from a marketing perspective, as a provider could sell a camera spot to a single sponsor, who could provide advertising on or around (e.g., a camera skin) the camera.

While the examples described above relate to a racetrack system, it should be recognized that the above is only an example. The system described herein places emphasis on end user fulfillment, regardless of the platform. Indeed, the present system may span across various platforms, including without limitation, sports, entertainment, film, interactive TV, reality TV, news, education, etc., where users may desire multiple views for more complete viewing of an event.

It will be apparent to those skilled in the art that, while exemplary embodiments have been shown and described, various modifications and variations can be made to the system and method for multi-screen experience disclosed herein without departing from the spirit or scope of the invention. Accordingly, it is to be understood that the various embodiments have been described by way of illustration and not limitation.

What is claimed is:

1. A method for providing a multi-screen experience, comprising:
simultaneous provision of multiple screens of information, each showing a different view of the event, to a viewer on a visible display.

2. The method for providing a multi-screen experience of claim 1, wherein a given screen may be selected by the viewer for full screen viewing or deselected for multi-screen viewing.

3. The method for providing a multi-screen experience of claim 1, wherein an identifier indicates, charts or illustrates how a given screen relates to an event.

4. The method for providing a multi-screen experience of claim 1, wherein an identifier indicates, charts or illustrates the progress of the event.

5. The method for providing a multi-screen experience of claim 1, wherein the display illustrates screens drawn from a computer network or the Internet.

6. The method for providing a multi-screen experience of claim 1, wherein the display illustrates screens drawn from an over the air television signal, satellite signal, cable television signal or prerecorded media.

7. The method for providing a multi-screen experience of claim 2, wherein screen may be selected via a keyboard, mouse or remote control device.

8. The method for providing a multi-screen experience of claim 1, wherein only screens showing activity are illustrated on the display.

9. The method for providing a multi-screen experience of claim 1, wherein the display illustrates screens drawn from a computer network or the Internet.

10. The method for providing a multi-screen experience of claim 1, wherein a viewer may select from a plurality of screens those screens the viewer would like to view on the display.
